(19) United States
(12) Patent Application Publication
(10) Pub. No.: US 2022/0297803 A1
(43) Pub. Date: Sep. 22, 2022

(54) BOAT ACCESSORY ATTACHMENT SYSTEM

(71) Applicant: Keith Redburn, Bay City, MI (US)

(72) Inventor: Keith Redburn, Bay City, MI (US)

(21) Appl. No.: 17/696,604

(22) Filed: Mar. 16, 2022

Related U.S. Application Data
(60) Provisional application No. 63/161,876, filed on Mar. 16, 2021.

(51) Int. Cl. B63B 25/00; B63B 17/00; F16M 11/10

(52) U.S. Cl. CPC B63B 25/002; B63B 17/00; F16M 11/10

(57) ABSTRACT

A boating accessory attachment system includes a mechanism that is selectively movable between first and second configurations. In the first configuration, one member of the mechanism is substantially vertical to support a boating accessory above the deck and/or fencing so that the boating accessory is accessible and usable by a occupant in the passenger area of the boat. In the second configuration, the member of the mechanism is rotated approximately ninety degrees to be substantially horizontal so that the mechanism supports the boating accessory above the water for use by someone swimming or lounging adjacent to the boat. A tubular receiver mounted to the underside of the deck facilitates attachment of the mechanism to the boat.

### CROSS-REFERENCE TO RELATED APPLICATION

This application claims the benefit of U.S. Provisional Patent Application No. 63/161,876, filed Mar. 16, 2021, and which is hereby incorporated by reference in its entirety.

### TECHNICAL FIELD

This disclosure relates to devices for attaching accessories to pontoon boats.

### BACKGROUND OF THE INVENTION

Boats and other watercraft are often used in conjunction with various accessories. In the case of recreational boating, for example, various recreational activities involve the use of devices and components that are used on or adjacent to the boat.

### SUMMARY

A boat having an accessory attachment system is provided. The boat includes a deck having an upper surface and a lower surface, first and second pontoons mounted to the deck, and a receiver mounted on the lower surface of the deck. The receiver is a tube. The accessory attachment system includes a mechanism having first, second, and third segments and first and second joints. The first segment extends into the receiver. The first joint rotatably interconnects the first segment and the second segment such that the second segment is perpendicular to the first segment. The second joint rotatably interconnects the second segment and the third segment such that the third segment is perpendicular to the second segment. An accessory holding portion is mounted to the third segment and configured to support a boating accessory.

The mechanism is movable between a first configuration and a second configuration. In the first configuration, the second segment is substantially vertical and supports the third segment and the accessory holding portion above the upper surface of the deck. In the second configuration, the second segment is substantially horizontal and supports the accessory holding portion above the surface of the water adjacent to the boat.

Accordingly, the accessory attachment system provided herein enables the placement of a boat accessory at a plurality of different positions relative to the boat. When the mechanism is in the first configuration, an accessory may be placed at first position in which the accessory is usable by a person on the deck of the boat in the passenger area. When the mechanism is in the second configuration, the accessory is usable by a person in the water adjacent to the boat. In the second configuration, the accessory holding portion is displaced horizontally by the length of the second segment (compared to the position of the accessory holding portion in the first configuration), thereby placing the accessory a significant distance from the boat.

In one embodiment, the accessory holding portion, and therefore the accessory, is forward of the bow of the boat when the mechanism is in the first configuration, and to the side of the boat when the mechanism is in the second configuration.

In another embodiment, the second segment is selectively slidable relative to the first segment such that the height of the accessory is variable when the second segment is vertical, and the horizontal distance of the accessory from the boat is selectively variable when the second segment is horizontal.

A corresponding method of using the accessory attachment system is also provided.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic, perspective view of a pontoon boat;

FIG. 2 is a schematic, cross-sectional, rear view of the boat of FIG. 1 with an accessory attachment system operatively connected thereto in a first configuration;

FIG. 3 is a schematic, perspective view of a portion of the boat and accessory attachment system in the first configuration;

FIG. 4 is a schematic, cross-sectional, side view of a portion of the boat and the accessory attachment system in the first configuration;

FIG. 5 is a schematic, cross-sectional, side view of a portion of the boat and the accessory attachment system in a second configuration;

FIG. 6 is a schematic, rear view of the boat with the accessory attachment system in the second configuration;

FIG. 7 is a schematic, perspective view of a portion of the boat with the accessory attachment system in the second configuration;

FIG. 8 is a schematic, perspective view of an alternative embodiment of an accessory attachment system within the scope of the claimed invention; and

FIG. 9 is another schematic, perspective view of the accessory attachment system of FIG. 8.

### DESCRIPTION OF THE PREFERRED EMBODIMENTS

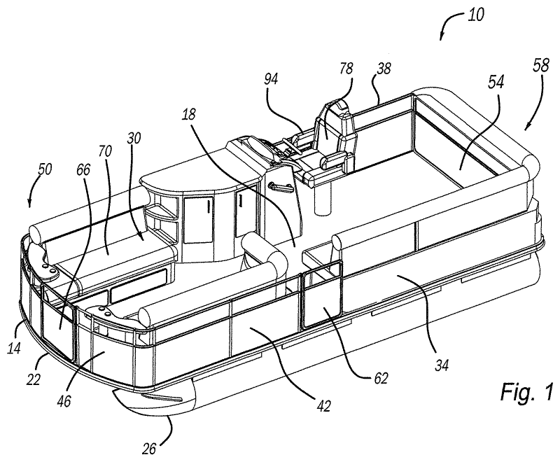

Referring to the Figures, wherein like reference numbers refer to like components throughout, a boat docking apparatus and method are schematically depicted. Referring specifically to FIG. 1, a pontoon boat 10 includes a platform or deck 14 having an upper surface 18 and a lower surface 22. The deck 14 is mounted with respect to pontoons 26, as understood by those skilled in the art. The upper surface 18 defines the floor of a passenger area 30. The pontoon boat 10 includes fencing 34 mounted to the deck 14 and extending upward from the upper surface 18.

The fencing 34 includes side portions 38, 42 that extend fore and aft or longitudinally along respective sides of the upper surface 18. The fencing 34 also includes a forward portion 46 at or adjacent to the bow 50. The forward portion 46 is generally perpendicular to, and interconnects, the side portions 38, 42. A rear portion 54 of the fencing 34 is at or adjacent to the stern 58. The rear portion 54 is generally perpendicular to, and interconnects, the side portions 38, 42. In the embodiment depicted, one of the side portions 42 includes a gate 62. Similarly, the forward portion 46 includes a gate 66.

The fencing 34 surrounds the passenger area 30, which may include seating assemblies 70, a steering wheel 74, a captain's chair 78, etc. The pontoon boat 10 may include a selectively retractable awning or canopy (not shown) as understood by those skilled in the art.

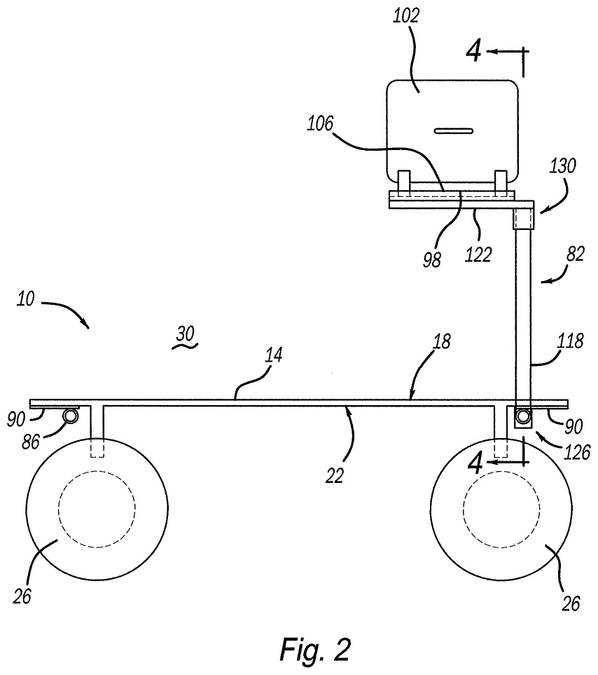

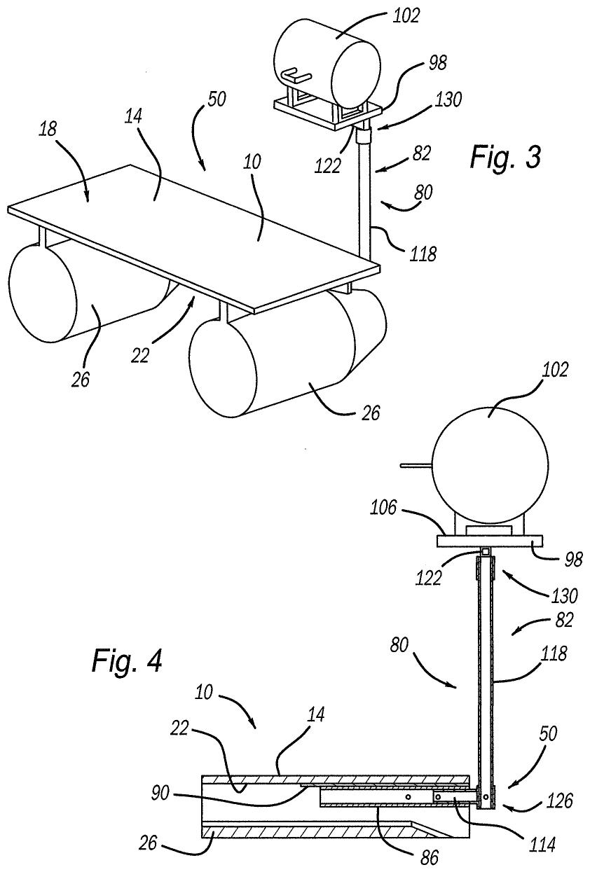

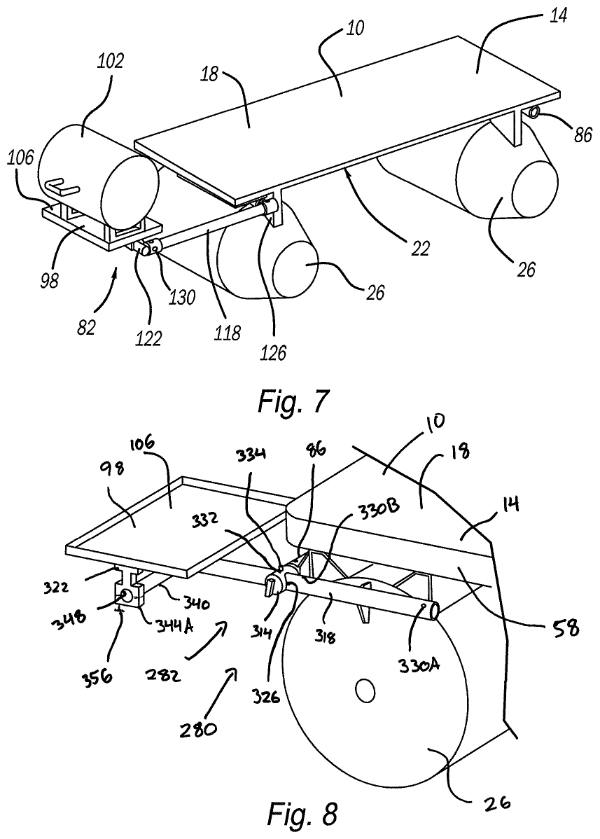

FIGS. 2-7, wherein like reference numbers refer to like components from FIG. 1, schematically depict an accessory attachment system 80 for use with the boat 10. In FIGS. 2-7, only the pontoons 26 and deck 14 of the boat 10, along with the receiver 86 and accessory attachment system 80, are shown for clarity and simplicity. Referring to FIGS. 2-7, the boat 10 has a receiver 86. The receiver 86 is tubular; in the embodiment depicted, the receiver 86 is cylindrical. In the embodiment depicted, the receiver is mounted to a plate 90, such as by welding. The plate 90 defines a plurality of holes for mounting the plate and, correspondingly the receiver 86, to the lower surface 22 of the deck 14 with fasteners (as shown). In the embodiment depicted, the boat includes two receivers 86 mounted under the deck 14 adjacent the bow; each receiver 86 is on a respective side of the boat 10.

The accessory mounting system 82 includes a mechanism that is attachable to the boat 10 via one of the receivers 86. The mechanism 82 includes an accessory holding portion 98 at which an accessory, such as the grill 102 shown, is connectable to the mechanism 82 or supportable by the mechanism 82. In the embodiment depicted, the accessory holding portion 98 is a table member defining at least one planar surface 106 on which an accessory is supportable by the mechanism 82. The grill 102 is shown in FIGS. 2-4 being supported by surface 106.

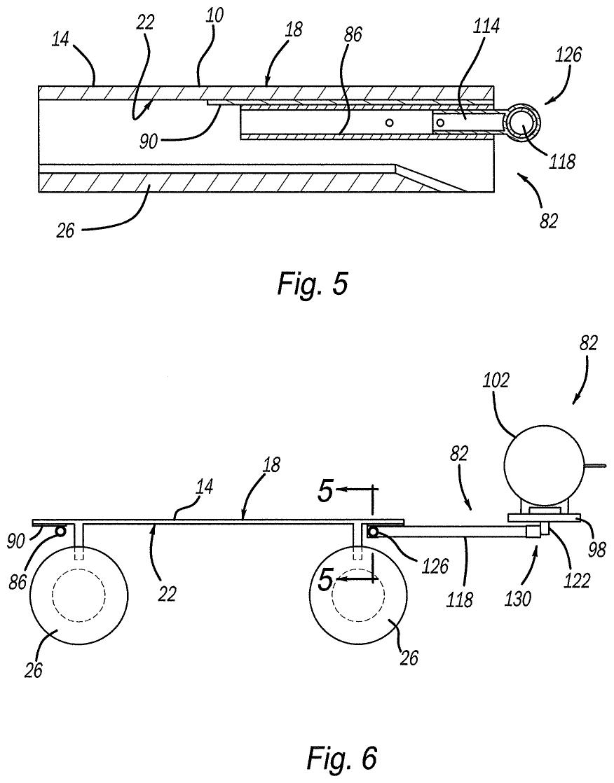

The mechanism 82 is reconfigurable such that the accessory holding portion 98 is selectively movable relative to the boat 10. For example, the mechanism 82 is reconfigurable between a first configuration, as shown in FIGS. 2-4, and a second configuration, as shown in FIGS. 5-7.

In the embodiment depicted, the mechanism 82 includes a first segment 114, a second segment 118, and a third segment 122. A first joint 126 interconnects the first and second segments 114, 118 such that the second segment 118 extends perpendicularly to the first segment 114. A second joint 130 interconnects the second and third segments 118, 122 such that the third segment 122 extends perpendicularly to the second segment 118.

The first joint 126 is configured such that the second segment 118 is selectively rotatable relative to the first segment 114 about an axis of rotation that extends along the centerline of the first segment. The second joint 130 is configured such that the third segment 122 is selectively rotatable relative to the second segment 118 about an axis of rotation that extends along the centerline of the second segment. The first segment 118 is insertable into one of the receivers 86 mounted to the underside of the deck 14 of the boat 10, and is selectively rotatable relative to the receiver 86.

Referring specifically to FIGS. 2-4, in the first configuration, the first segment 114 extends in the fore and aft direction (relative to the boat 10) from the receiver 86 to a point forward of the bow 50. The second segment 118 extends vertically forward of the bow 50, and the third segment 122 extends transversely or laterally with respect to the boat 10 (i.e., perpendicularly to both the first segment 114 and the second segment 118.

The accessory holding portion 98 is attached to the third segment 122, and the grill 102 is placed on one of the surfaces 106 of the accessory holding portion 98 to be supported in the position shown in FIGS. 2-4. In the first configuration, the attachment portion 98 is in a position to support the grill 102 where the grill 102 is usable by a person on the deck 14 in the passenger area 30. More specifically, the attachment portion 98 and therefore the grill 102, is above the deck 14 and the upper edge of the fencing 34 when the mechanism 82 is in the first configuration.

Referring to FIGS. 5-7, the mechanism is movable from the first configuration to the second configuration by rotating the first, second, and third segments 114, 118, 122 about the joints 126, 130 and/or rotating the first segment 114 relative to the receiver 86 such that the second segment 118 is substantially horizontal, and the attachment portion 98, and therefore the grill 102, are moved downward, rearward, and rightward relative to the boat from the first configuration.

When the mechanism 82 is in the second configuration, the grill 102 is in a position for use by a person in the water adjacent the boat. More specifically, as shown in FIGS. 5-7, when the mechanism 82 is in the second configuration, the Accordingly, the accessory attachment system enables a user to place accessories in various positions relative to the boat. Other accessories attachable or supportable by the attachment portion 98 may include lights, speakers, fishing equipment, etc.

In the embodiment depicted, the joints 126, 130 are formed by collars into which the segments extend, and are lockable by inserting pins into aligned holes in the collars and the segments. However, other joint configurations that provide the same functionality may be employed within the scope of the claimed invention. For example, clamps may be employed to selectively lock segments relative to one another within the scope of the claimed invention. Similarly, the receiver 86 defines holes that align with holes in the first segment 114, such that the first segment 114 is lockable relative to the receiver 86 by extending pins through the holes in the receiver and first segment.

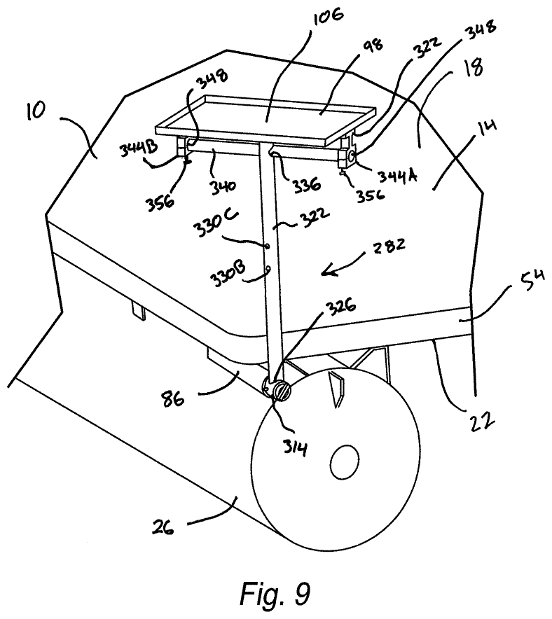

FIGS. 8 and 9, wherein like reference numbers refer to like components from FIGS. 1-7, schematically depict another accessory attachment system 280 according to an alternative embodiment. In the embodiment depicted, the system 280 includes a mechanism 282 having a first segment 314, a second segment 318, and a third segment 322. The first segment 314 is cylindrical and is inserted into the receiver 86 in a manner similar to the first segment shown at 114 in FIGS. 2-7. In the embodiment shown in FIGS. 8 and 9, the receiver 86 is mounted below the deck 14 to a vertical surface on a bracket that interconnects one of the pontoons 26 to the deck 14 adjacent to the stern 58.

The first segment 314 is selectively rotatable relative to the receiver 86 and is selectively lockable via pins in the positions shown in FIGS. 8 and 9. The first segment 314 also defines a hole 326 that extends perpendicular to the centerline of the segment 314, i.e., the hole 326 extends through the width of the segment 314. The second segment 318 extends through the hole 326 such that the second segment 318 is perpendicular to the first segment 314. The outer diameter of the second segment 318 is slightly smaller than the diameter of the hole 326 such that the second segment 318 is slidable through the hole 326 relative to the first member 314.

The second segment 318 defines a plurality of holes 330A, 330B, 330C along its length. Hole 330A is near one end of the second segment 318, and holes 330B, 330C are near the midpoint of the second segment 318. The first segment 314 defines a hole 332 that extends from the outer surface into the hole 326. The second segment 318 is lockable relative to the first segment 314 by aligning one of the holes 330A, 330B, 330C with the hole 332 and then inserting a pin 334 through hole 332 and one of holes 330A, 330B, 330C.

The second segment 318 defines another hole 336 extending therethrough. Hole 336 is perpendicular to the centerline of the second segment 318. A cylindrical member 340 extends through the hole 336 such that the cylindrical member 340 is perpendicular to the second segment 318. The third segment 322 is rotatably connected to member 340 via two clamps 344A, 344B.

More specifically, each clamp 344A, 344B defines a respective cylindrical hole 348 through which member 340 extends so that the clamps 344A, 344B are rotatable about an axis that is coextensive with the centerline of the member 340 and perpendicular to the second segment 318. Each clamp 344A, 344B also includes a respective hand knob 356 that varies the clamping force exerted by the clamps 344A, 344B on the member 340. Accordingly, the rotation of clamps 344A, 344B, and therefore the rotation of the third segment 322, relative to the member 340 and segment 318, is prevented by rotating the hand knobs 356 in one direction to increase the clamping force on the member 340. If a user desires to alter the angular position of the third segment relative 322 to the member 340 and the second segment 318, the user may rotate the knobs 356 in the opposite direction to permit rotation of the third segment 322.

Accordingly, the clamps 344A, 344B permit fine adjustments to the angular position of the third segment 322. The accessory holding portion 98 is rigidly connected to the third segment 322 for unitary movement therewith, and thus the angular position of the accessory holding portion 98 is adjustable via the clamps 344A, 344B.

In FIG. 9, the first segment 314 is positioned relative to the receiver 86 and the boat 10 so that the second segment 318 is vertically oriented. The pin 334 extends through hole 330A, and thus the distance from the receiver 86 to the accessory holding portion 98 is maximized. The surface 106 faces upward to support a grill or other accessory.

In FIG. 8, the first segment 314 has been rotated ninety degrees relative to the receiver 86 from its position in FIG. 9. The second segment 318 has been slid through the hole 326 so that the pin 334 is inserted through hole 330C; accordingly, the distance between the receiver 86 and the accessory holding portion 98 has been shortened compared to FIG. 9. The third segment 322, and therefore the accessory holding portion 98, has been rotated about approximately ninety degrees relative to the second segment 318 from the position shown in FIG. 9 so that, despite the rotation of the second segment 318, the surface 106 maintains its upwardly-facing orientation.

While the best modes for carrying out the invention have been described in detail, those familiar with the art to which this invention relates will recognize various alternative designs and embodiments for practicing the invention within the scope of the appended claims.

1. A boat comprising:
a deck having an upper surface and a lower surface;
first and second pontoons mounted to the deck;
a receiver mounted on the lower surface of the deck, said receiver being a tube;
a mechanism having first, second, and third segments and first and second joints;
said first segment extending into the receiver;
said first joint rotatably interconnecting said first segment and said second segment such that the second segment is perpendicular to the first segment;
said second joint rotatably interconnecting said second segment and said third segment such that the third segment is perpendicular to the second segment;
an accessory holding portion mounted to the third segment and configured to support a boating accessory;
said mechanism being movable between a first configuration in which the second segment is substantially vertical and supports the third segment and the accessory holding portion above the upper surface of the deck, and a second configuration in which the second segment is substantially horizontal.

2. The boat of claim 1, wherein said first and second joints are selectively lockable to prevent relative movement between the first, second, and third segments.

3. The boat of claim 1, further comprising fencing that cooperates with the upper surface to define a passenger area; and
wherein the third segment and the accessory holding portion is above the fencing when the mechanism is in the first configuration.

4. The boat of claim 1, further comprising an accessory supported by the accessory holding portion.

5. The boat of claim 4, wherein the accessory is one of a grill, a light, a speaker, and fishing equipment.

6. A method comprising:
possessing a boat including a deck having an upper surface and a lower surface, first and second pontoons mounted to the deck, and a receiver mounted on the lower surface of the deck, said receiver being a tube;
possessing a mechanism having first, second, and third segments, first and second joints, and an accessory holding portion;
said first joint rotatably interconnecting said first segment and said second segment such that the second segment is perpendicular to the first segment;
said second joint rotatably interconnecting said second segment and said third segment such that the third segment is perpendicular to the second segment;
said accessory holding portion being mounted to the third segment and configured to support a boating accessory;
inserting said first segment into the receiver.

7. The method of claim 6, further comprising arranging the mechanism such that the first second segment is substantially vertical.

8. The method of claim 7, further comprising rotating the second segment relative to the boat such that the second segment is substantially horizontal.

9. The method of claim 8, further comprising placing a boating accessory on the accessory holding portion.

10. A boat comprising:
a deck having an upper surface and a lower surface;
first and second pontoons mounted to the deck;
a receiver mounted to the boat below the deck, said receiver being a tube;
a mechanism having first, second, and third segments;
said first segment extending into the receiver and being selectively rotatable with respect to the receiver;
said second segment being operatively connected to the first segment such that the second member is perpendicular to, and selectively slidable relative to, the first segment;
said third segment being selectively rotatable with respect to the second segment;
an accessory holding portion mounted to the third segment for unitary movement therewith and configured to support a boating accessory;
a cylindrical member operatively connected to the second segment; and
at least one clamp mounted to the third segment and configured to selectively apply sufficient clamp force on the cylindrical member to prevent the rotation of the third segment relative to the second segment.
